(19) United States
(12) Patent Application Publication
(10) Pub. No.: US 2016/0101537 A1
(43) Pub. Date: Apr. 14, 2016

(54) Food Slicer Hand Guard

(71) Applicant: John L. Schoeman, Mona Vale (AU)

(72) Inventor: John L. Schoeman, Mona Vale (AU)

(21) Appl. No.: 14/510,028

(22) Filed: Oct. 8, 2014

(51) Int. Cl. B26D 7/06; B26D 7/22; B26D 7/02

(52) U.S. Cl. CPC B26D 7/0608; B26D 7/02; B26D 7/225

(57) ABSTRACT

Various embodiments of a food slicer hand guard/pusher having means to hold the food vertically or horizontally, protect the user's fingers and wrists and cover a sharp blade of any slicer are provided.

### BACKGROUND

When preparing foods, it may be necessary to cut certain foods into smaller pieces, such as when slicing a carrot or a tomato. Such cuts are commonly made with knives, manual food slicers, or food processors. Each of these methods require a certain degree of control of both the food to be cut and the means with which to cut the food. For example, when cutting food with a food slicer, depending upon the design of the food slicer, the user must hold the food and move the slicer relative to the food, or hold the slicer and move the food relative to the slicer. Both of these methods increase the chance for injury due to the user's hand coming into close proximity with and ultimately contacting the cutting surface of the food slicer.

Various protective tools such as hand guards or special gloves exist to aid a user in slicing food safely with a slicer. However, these tools are limited with respect to providing freedom to orient the food to be cut in the desired position relative to the slicer. For example, some tools allow for the food to be held such that it may be pushed axially past a cutting blade—thereby creating strips of food—but do not allow the food to be held such that it may be cut into slices. To illustrate this distinction, such a food slicer may cut a carrot lengthwise into long slices or strips as the carrot is pushed downward through the cutting blades. However, such a food slicer is not capable of cutting a carrot into round, flat cross-sectional slices. As a result, a user who desires the food to be cut into round, flat cross-sectional slices must resort to some other means of cutting food, such as by using a knife to cut slices of food while holding the food in his/her hand. This process may be safe and fast for highly-skilled users, but it may prove to be cumbersome and even dangerous for less-skilled users who lack the control and dexterity necessary to execute such slicing cuts safely and quickly.

What is needed is a tool for cutting food with a food slicer such that risk of injury due to the user's hand coming into contact with the cutting blade is reduced, while also allowing the user to orient the food such that it may be cut into round, flat cross-sectional slices, in addition to lengthwise slices or strips, depending on the shape of the food to be cut.

### SUMMARY

In one embodiment, a food slicer hand guard is provided, the food slicer hand guard comprising: a clamping portion having a first arm and a second arm, wherein the first arm is operatively connected to the second arm so as to allow the clamping portion to open and close; a first extension attached to the first arm; and a second extension attached to the second arm.

In one embodiment, a food slicer is provided, the food slicer comprising: a base portion; a cutting portion having one or more blades; a working surface; and a hand guard, comprising: a clamping portion having a first arm and a second arm, wherein the first arm is operatively connected to the second arm so as to allow the clamping portion to open and close; a first extension attached to the first arm; and a second extension attached to the second arm.

In one embodiment, a method for cutting flat, cross-sectional slices of a food is provided, the method comprising: placing an item of food vertically into a hand guard, wherein the hand guard comprises: a clamping portion having a first arm and a second arm, wherein the first arm is operatively connected to the second arm so as to allow the clamping portion to open and close; a first extension attached to the first arm; and a second extension attached to the second arm; preparing a food slicer to receive the food, wherein the food slicer comprises: a base portion; a cutting portion having one or more blades; and a working surface; placing the hand guard in contact with the working surface of a food slicer; and sliding the hand guard repeatedly in opposing directions across the cutting portion of the food slicer until the desired number of slices have been cut.

### BRIEF DESCRIPTION OF THE DRAWINGS

The accompanying figures, which are incorporated in and constitute a part of the specification, illustrate various example apparatuses and are used merely to illustrate various example embodiments.

FIG. 1 is a perspective view of a food slicer hand guard showing a new design, wherein the food slicer hand guard is in an open position.

FIG. 2 is a perspective view of the food slicer hand guard of FIG. 1 in a closed position.

FIG. 3 is a rear perspective view of the food slicer hand guard of FIG. 1 in the open position.

FIG. 4 is a rear perspective of the food slicer hand guard of FIG. 1 thereof in the closed position.

FIG. 5 is a bottom perspective view of the food slicer hand guard of FIG. 1 in the open position.

FIG. 6 is a bottom perspective view of the food slicer hand guard of FIG. 1 in the closed position.

FIG. 7 is a top plan view of the food slicer hand guard of FIG. 1 in the open position.

FIG. 8 is a top plan view of the food slicer hand guard of FIG. 1 in the closed position.

FIG. 9 is a bottom plan view of the food slicer hand guard of FIG. 1 in the open position.

FIG. 10 is a bottom plan of the food slicer hand guard of FIG. 1 thereof in the closed position.

FIG. 11 is a front elevational view of the food slicer hand guard of FIG. 1 in the open position.

FIG. 12 is a front elevational view of the food slicer hand guard of FIG. 1 in the closed position.

### DETAILED DESCRIPTION

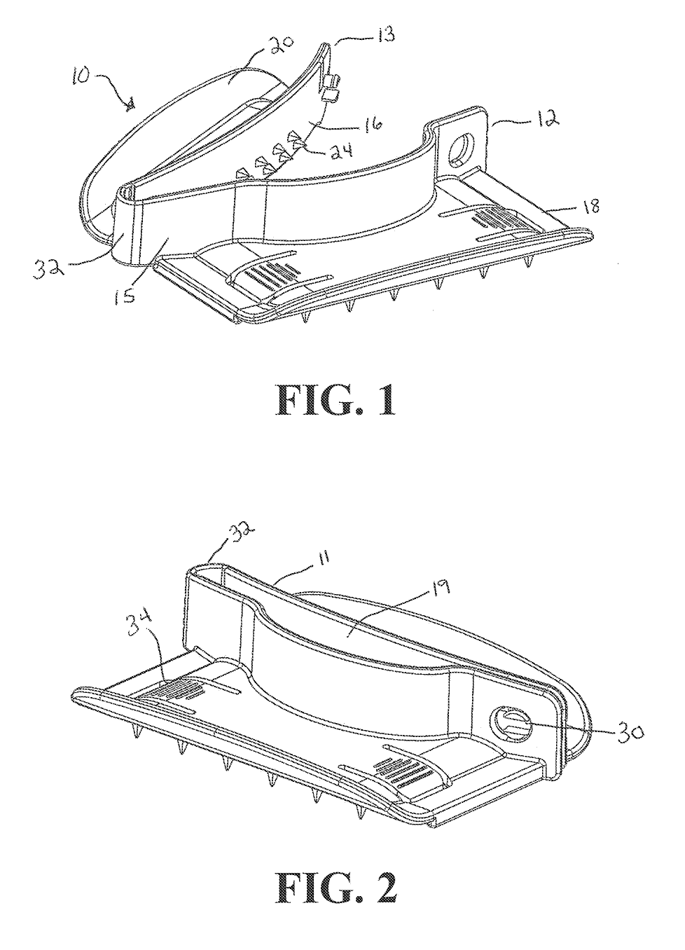

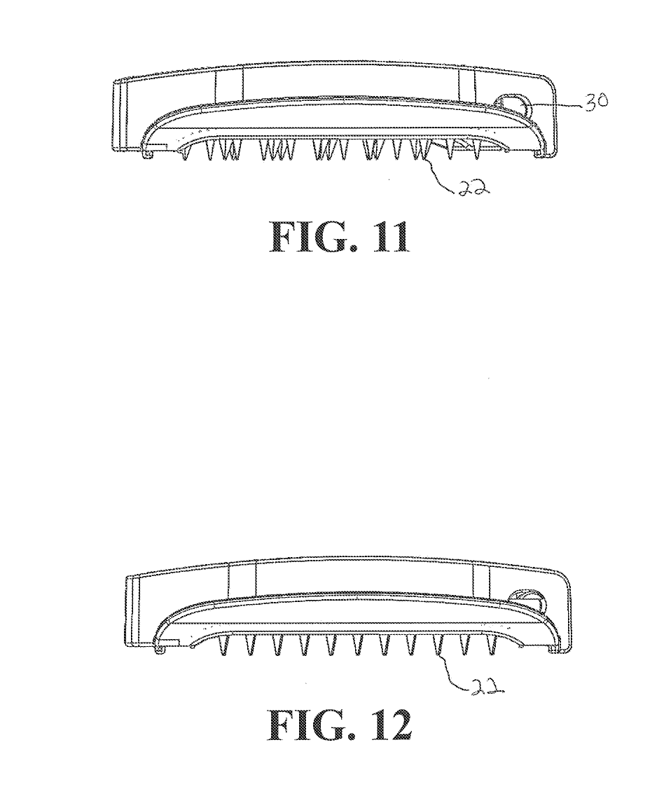

FIGS. 1-12 illustrate one embodiment of a hand guard/pusher 10 having a clamping portion 11 made of flexible material including but not limited to a polymer, a metal, a composite, a rubber, a silicone, a rubberized plastic, or any other material that is flexible enough to expand or bend in accordance to the contours of the food item to be sliced. The clamping portion 11 may be generally smooth and/or rectangular in shape with a first arm 12 and a second arm 13 that are either continuous or discontinuous. The first arm 12 and the second arm 13 may both have a centrally curved portion compared to their elongated ends. Hence, when the two arms come in close proximity a semi-circular or eye-shaped open cavity 19 may be formed. Open cavity 19 may be oriented generally in a central portion of first arm 12 and second arm 13, where the two arms do not touch each other (FIG. 2). This open cavity may be dimensioned in such a way to receive and hold a food item with an elongated shape, such as a carrot, a cucumber, a zucchini and the like.

In one embodiment, the two arms of the clamping portion 11 are operatively connected by a structure 32 that allows the first arm and the second arm to open and close. The structure that facilitates opening or closing of the arms may be selected from the group comprising a hinge, a pivot, a pin, a bolt, a screw, a ball-and-socket, and a flexible material. For the purpose of describing this embodiment, the structure 32 will be referred to as a hinge. Hinge 32 may allow first arm 12 and second arm 13 to angularly displace relative to one another, such that the angle between them may selectively vary. The angle between first arm 12 and second arm 13 may be positive or negative. The angle between first arm 12 and second arm 13 may be between about −10 degrees and about 90 degrees.

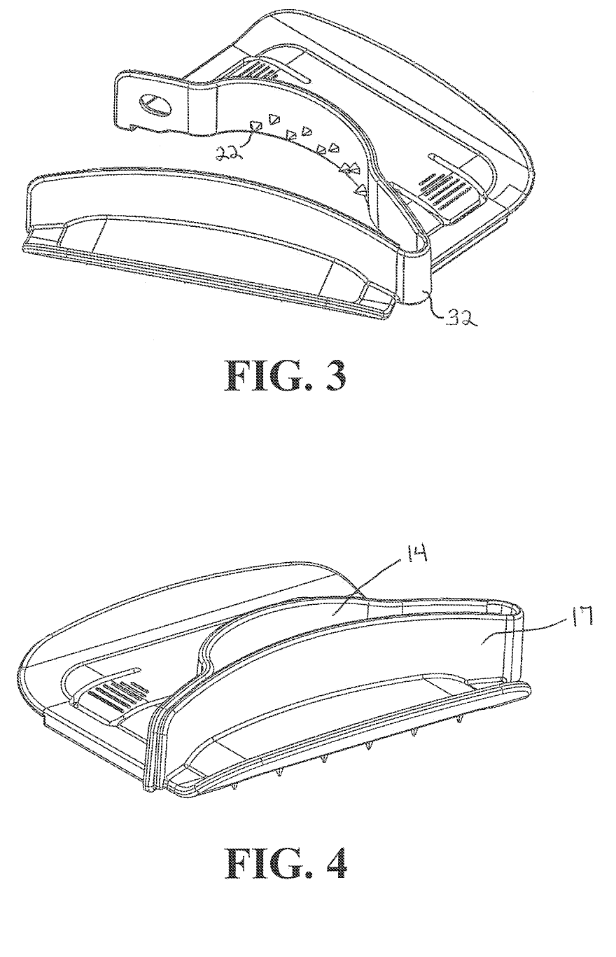

The two arms of the clamping portion 11 may have inner clamping surfaces 14, 16 that come into direct contact with the food item to be sliced and outer surfaces 15, 17 that are graspable by a user (FIGS. 1 and 4). In one embodiment, first arm 12, second 13 arm, and hinge 32 (FIG. 3) are all formed of the same material. Hinge 32, connecting arms 12 and 13 may also be made of different materials. Inner clamping surfaces 14 and 16 may further include at least one spike attached to them to aid in gripping the food item grasped between them.

As shown in FIGS. 1 and 3, each of the clamping surfaces may have plurality of protruding spikes 22 and 24. Spikes 22 and 24 may be spread equidistant from each other about the entire surface. Spikes 22 and 24 may be oriented in any arrangement or pattern. This design may offer enhanced grip of a food item with an elongated shape that can be held vertically. While the spikes 22 and 24 may be generally pyramid shaped, it is also possible to have simple protrusions that are dome shaped, cone shaped, semi-circular shaped, cylindrically-shaped, rectangular in shape, or the like. Irrespective of the shape, it will be understood that spikes 22 and 24 are sufficiently rough to at least partially penetrate and/or indent the food item and enable grasping the food firmly during the slicing operation. Spikes 22 and 24 may be formed of any suitable material including but not limited to a metal, a polymer, or the same material as the hand guard/pusher 10. A lock 30 may be disposed on the free ends of first 12 and second arm 13 (FIG. 2) in order to selectively hold the arms 12 and 13 in a closed position.

Before slicing a food item held vertically, arms 12 and 13 of the clamping portion 11 may be opened by releasing the lock 30. After the food is placed in the desired orientation including vertically between inner clamping surfaces 14 and 16, arms 12 and 13 may be closed and held by the user's hand. Lock 30 may be engaged. The vertically held food item may be sliced by reciprocally moving the food item toward the blade to slice the food item until the desired quantity is reached or until the food item in its original state is depleted.

Lock 30 may include a tab for engaging an aperture. Lock 30 may be selected from the group comprising, a pin, a clamp, a hook and loop, a slot, a notch, a magnet, an elastic rubber band, a string, a screw, a hook, an adhesive, or the like. In one embodiment, one end of the arm (for example, 12) can include one or more locking tabs and the corresponding end of the opposite arm (for example, 13) can include an aperture into which the tab fits in (FIG. 2).

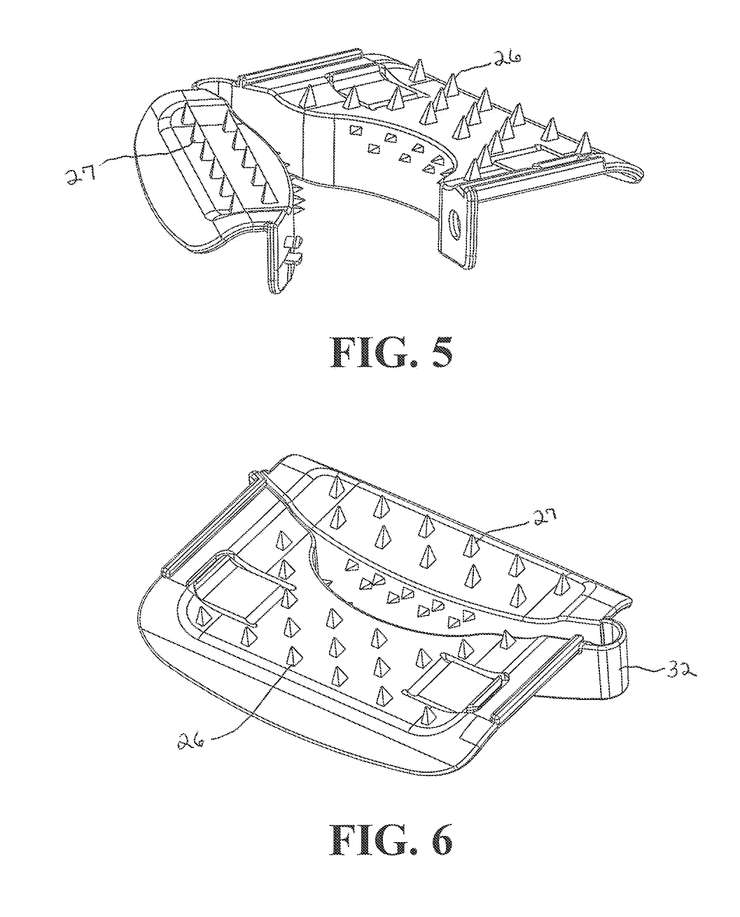

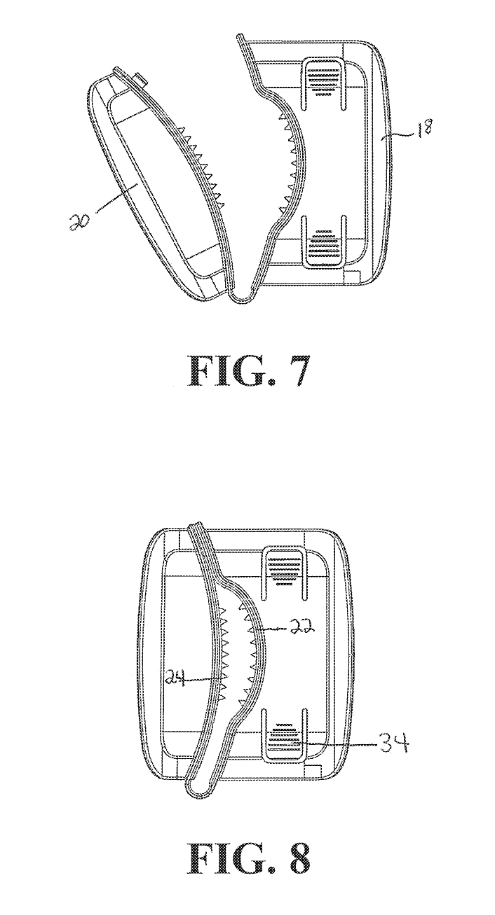

First arm 12 and second arm 13 of hand guard/pusher device 10 may further include a first extension 18 and a second extension 20 that may be perpendicular to the vertical axis of the arms (FIGS. 1 and 7). First extension 18 and second extension 20 may be generally rectangular in shape with a distal end, a proximal end, an upper surface, and a lower surface. The proximal ends of both extensions 18, 20 may engage clamping portion 11 while the distal ends may be free. The upper surface of the extensions may be designed to enable a user to rest their fingers and/or wrists during slicing while the bottom surface of the extensions contact the cutting surface of the slicer or the food placed thereunder. Extensions 18, 20 may be formed of the same material as clamping portion 11 of hand guard/pusher 10. Extensions 18, 20 may be formed of a different material from clamping portion 11. For instance, while clamping portion 11 may be formed of a rubberized plastic or silicone material, the extensions may be made of plastic or stainless steel. While the extensions formed on either side of the arms may be sufficiently thick to protect the user's hand from the sharp blade, they may not be uniform in dimension. For example, extension 18 from first arm 12 may be wider than extension 20 from second arm 13. And both extensions 18 and 20 may have at least one spike disposed on the bottom surface that comes in contact with the food slicer platform. In one embodiment, both extensions 18 and 20 may have plurality of spikes 26, 27 oriented on their lower surfaces. Spikes 26, 27 may be positioned equidistant from one another. Spikes 26, 27 may be oriented in any pattern or arrangement. Spikes 26, 27 may be oriented in a way to engage a food item, such as an onion or a tomato (FIGS. 5 and 6).

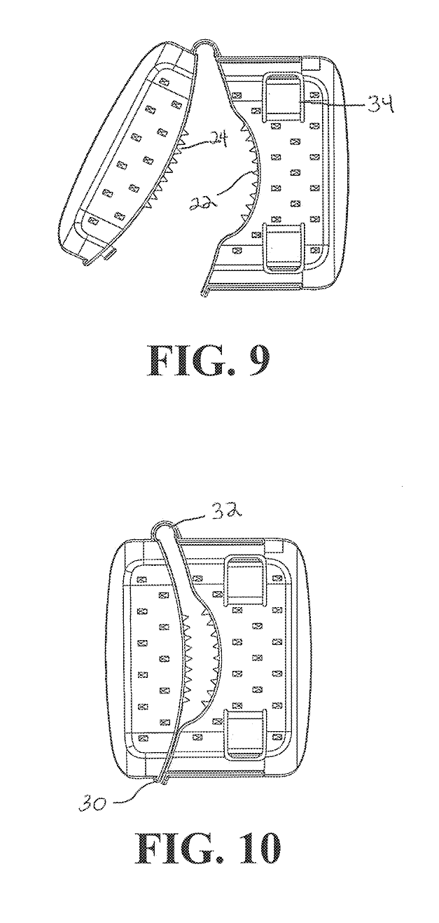

Extensions 18 and 20 may form a shield designed to protect the user's fingers and palm or wrist when slicing the food and provide for a more traditional orientation of a food item. However extension 18 may also include at least a pair of securing elements 34 placed laterally on the top surface to secure hand guard/pusher 10 over the blade (FIGS. 8 and 9). In this arrangement, hand guard/pusher 10 serves as a blade cover when the slicer is not in use. Securing element 34 may be a simple hatch or a tab or may be selected from the group comprising a pin, a clamp, a hook and loop, a slot, a notch, a magnet, an elastic, a rubber band, a string, a screw, a hook, an adhesive, and the like. Before the slicer is placed in storage, the hand guard/pusher 10 may be positioned over the blade and the securing element, preferably the two tabs are pressed down to lock hand guard/pusher 10 onto a food slicer. To unlock the securing tabs 34, the hand guard/pusher 10 may simply be pushed forward to the end of the slicer.

Thus the same hand guard/pusher device 10 is a multi-functional kitchen tool that may provide a firm grip to a food item while slicing, may allow food to be held vertically while slicing, may protect the user's hand from the sharp slicing blade, and may serve as a blade cover when the slicer is not in use.

In operation, arms 12 and 13 of hand guard/pusher 10 are opened by releasing lock 30. The food item is then placed between inner clamping surfaces 14, 16. By this operation spikes 24 present on inner surfaces may engage the food gently and keep it in place. If the user desires to slice a carrot or a zucchini (or any elongated food item) vertically, then the food item may be held vertically between the inner clamping surfaces. Once the food is firmly grasped, the user may hold hand guard/pusher 10 by the clamping portion 11 so that the palm and the fingers rest on the extensions 18 and 20 from the first 12 and second arm 13, respectively. The user may then slice the food by reciprocally moving the food item toward the blade to slice the food item until the desired quantity is reached or until the food item is depleted.

Hand guard/pusher 10 may also be used in a closed position, as shown in FIGS. 2 and 6, to slice food that has been placed in contact with the bottom surfaces of extensions 18 and 20 and the food slicer. In this orientation, the food item may be held in place with spikes 26 and 27 disposed on the bottom surfaces of extensions 18 and 20.

In some embodiments, hand guard/pusher 10 disclosed herein can be a part of a food slicer kit. Accordingly, the kit may comprise a food slicer having a stationary or a removable blade, wherein the blade can provide food slices of different cuts or thickness, a hand guard/pusher as disclosed herein, and an operation manual.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

What is claimed is:

1. A food slicer hand guard, comprising:
a clamping portion having a first arm and a second arm, wherein the first arm is operatively connected to the second arm so as to allow the clamping portion to open and close;
a first extension attached to the first arm; and
a second extension attached to the second arm.

2. The hand guard of claim 1, wherein the first arm and the second arm each have an inner clamping surface that contacts a food item to be sliced and an outer surface that is graspable by a user.

3. The hand guard of claim 2, wherein at least one spike is attached to the inner clamping surfaces so that the at least one spike is oriented to at least partially penetrate the food item to be sliced.

4. The hand guard of claim 1, wherein the first arm is operatively connected to the second arm by at least one of the connections selected from the group comprising a hinge, a pivot, a pin, a bolt, a screw, a ball-and-socket, and a flexible material.

5. The hand guard of claim 1, wherein the first extension and the second extension each have an upper surface and a lower surface.

6. The hand guard of claim 5, wherein the upper surface of the first extension and the upper surface of the second extension serve as a shield to protect a user's hand when operating the hand guard.

7. The hand guard of claim 5, wherein at least one spike is attached to the lower surface of the first extension and the lower surface of the second extension.

8. The hand guard of claim 1, further comprising a locking device operatively connected to at least one of the first arm and the second arm, such that the clamping portion can be locked in a closed position.

9. The hand guard of claim 8, wherein the locking device is selected from the group comprising a tab, a pin, a clamp, a hook and loop, a slot, a notch, a magnet, an elastic, a rubber band, a string, a screw, a hook, and an adhesive.

10. The hand guard of claim 1, further comprising at least one securing element operatively connected to the first extension, wherein the at least one securing element engages a blade of the slicer.

11. The hand guard of claim 10, wherein the at least one securing element is selected from the group comprising a tab, a pin, a clamp, a hook and loop, a slot, a notch, a magnet, elastic, a rubber band, a string, a screw, a hook, and an adhesive.

12. The hand guard of claim 1, wherein the first arm and the second arm are configured to hold a food item vertically or horizontally when the first extension and second extension are oriented horizontally.

13. A food slicer, comprising:
a base portion;
a cutting portion having one or more blades;
a working surface; and
a hand guard, comprising:
a clamping portion having a first arm and a second arm, wherein the first arm is operatively connected to the second arm so as to allow the clamping portion to open and close;
a first extension attached to the first arm; and
a second extension attached to the second arm.

14. The food slicer of claim 13, wherein the first arm and the second arm each have inner clamping surfaces that contact a food item to be sliced, and outer surfaces that are graspable by a user.

15. The food slicer of claim 14, wherein the inner clamping surface of the first arm and the inner clamping surface of the second arm have at least one spike attached to them so that the at least one spike is oriented to at least partially penetrate the food to be cut.

16. The food slicer of claim 13, wherein the first extension and the second extension each have an upper surface and a lower surface.

17. The food slicer of claim 16, wherein the lower surface of the first extension and the lower surface of the second extension each have at least one spike attached to the lower surfaces.

18. The food slicer of claim 16, wherein the upper surface of the first extension and the upper surface of the second extension form a shield serving to protect a user's hand when operating the hand guard.

19. The food slicer of claim 13, wherein the hand guard further comprises a locking device operatively connected to the first arm and the second arm, such that the clamping portion can be locked in a closed position.

20. The food slicer of claim 19, wherein the hand guard locking device is selected from the group comprising a tab, a pin, a clamp, a hook and loop, a slot, a notch, a magnet, an elastic, a rubber band, a string, a screw, a hook, and an adhesive.

21. The food slicer of claim 13, wherein the first arm is operatively connected to the second arm by at least one of the connections from the group comprising a hinge, a pivot, a pin, a bolt, a screw, a ball-and-socket, and a flexible material.

22. The food slicer of claim 13, wherein the hand guard further comprises at least one securing element operatively connected to the first extension, wherein the securing element serves to secure the hand guard over the blade of a slicer.

23. The food slicer of claim 22, wherein the at least one securing element of the hand guard is selected from the group comprising a tab, a pin, a clamp, hook and loop, a slot, a notch, a magnet, elastic, a rubber band, a string, a screw, a hook, and an adhesive.

24. A method for cutting flat, cross-sectional slices of a food, comprising:
placing an item of food vertically into a hand guard, wherein the hand guard comprises:
a clamping portion having a first arm and a second arm, wherein the first arm is operatively connected to the second arm so as to allow the clamping portion to open and close;
a first extension attached to the first arm; and
a second extension attached to the second arm,
wherein the first extension and the second extension are oriented horizontally;
preparing a food slicer to receive the food, wherein the food slicer comprises:
a base portion;
a cutting portion having one or more blades; and
a working surface;
placing the hand guard in contact with the working surface of a food slicer; and
sliding the hand guard repeatedly in opposing directions across the cutting portion of the food slicer until the desired number of slices have been cut.
